(19) United States
(12) Patent Application Publication
(10) Pub. No.: US 2006/0066271 A1
(43) Pub. Date: Mar. 30, 2006

(54) Control device for three phase ac generator-motor

(75) Inventors: Tadashi Yamazaki, Tsurugashima-shi (JP); Junichi Takahashi, Tsurugashima-shi (JP); Takeo Fukushima, Tsurugashima-shi (JP)

Correspondence Address: FULBRIGHT AND JAWORSKI LLP, 555 S. FLOWER STREET, 41ST FLOOR, LOS ANGELES, CA, 90071, US

(73) Assignee: Toyo Denso Kabushiki Kaisha

(21) Appl. No.: 10/953,718

(22) Filed: Sep. 28, 2004

(51) Int. Cl. H02P 5/20

(52) U.S. Cl. 318/140

(57) ABSTRACT

For a control circuit of a three-phase alternating current motor-generator, which serves as a three-phase rectifier circuit for charging a battery with power generated by driving the motor-generator as a generator and which also serves as a three-phase inverter circuit for driving the motor-generator as a motor by using a battery and uses MOSFETs as control elements for each of three phases, a control device is provided, which, in case of driving the motor-generator as the three-phase ac generator, uses means for making synchronous rectification by using MOSFETs only on the negative potential side of respective phases and means for delaying and advancing an electric angle of the current carrying control timing by gate control of MOSFETs on negative potential side. When operating the motor-generator to charge the battery, this control device can easily perform the current carrying control for three-phase rectification and effectively generate a constant charging voltage without affection of variations in rotation speed and load.

### BACKGROUND OF THE INVENTION

The present invention relates to a control device of three-phase alternating-current motor-generator, which conducts the current carrying control of a control circuit which works as a three-phase inverter circuit for driving the motor-generator as a three-phase alternating-current motor by using a battery and also works as a three-phase rectifier circuit for driving the motor-generator as a three-phase alternating-current generator for charging the battery.

In general, a three-phase ac motor-generator is mounted in a vehicle, which works both as a three-phase ac motor with a battery power supply through a three-phase ac inverter circuit when starting an engine of the vehicle and a three-phase ac generator for charging the battery through a three-phase rectifier circuit after starting the engine.

Recently, there has been used a control circuit which can work as a three-phase inverter circuit when driving the three-phase ac motor-generator as a motor and can also work as a three-phase ac rectifier for driving the motor-generator as a generator for charging the battery and which is featured, as shown in FIG. 1, by using MOS field-effect transistors MOSFET 1 to 6 as control elements for respective phases U, V and W in the circuit.

In FIG. 1, M/G designates a three-phase alternating-current motor-generator of the permanent magnet type, Batt designates a battery and D designates a In the above-described conventional control circuit for parasitic diode.
the three-phase ac motor-generator, the current carrying control is conducted, as shown in FIG. 2, by turning on and off the gates of MOSFETs 1 to 6 both on the positive and negative potential sides for respective phases under the control of a controller (not shown) when operating the motor-generator as the generator for charging the battery Batt.

The problems to be solved by the present invention are as follows:

The conventional control circuit of a three-phase ac motor-generator, which can work both as a three-phase inverter circuit for driving a motor with power supply from a battery and a rectifier circuit for driving a generator for charging the battery and which uses MOS field-effect transistors as control elements for respective phases, must perform the current carrying control by turning on and off the gates of MOSFETs both on the positive and negative sides of respective phases when driving the motor-generator for charging the battery. This complicates the control operation of the control device.

Furthermore, in the case of charging the battery with output power produced by the three-phase ac generator, the output voltage of the generator may be affected by the variations in the load current and rotations per minute of the generator, causing the fluctuation of the battery charging voltage.

### SUMMARY OF THE INVENTION

It is therefore a primary object of the present invention to provide a control device for three-phase alternating-current motor-generator, which conducts the current carrying control of a control circuit which can work both as a three-phase inverter for driving the motor-generator as a three-phase ac generator by using a battery and a three-phase rectifier for driving the motor-generator as a three-phase ac generator for generating power for charging the battery and which uses MOSFETs (Metal Oxide Silicone Field Effect Transistors) as control elements for respective phases, wherein the control device uses a means for performing synchronous rectification by using MOSFETs only on the negative potential side for respective phases in the control circuit when driving the motor-generator for charging the battery and a means for leading and lagging the angle of current carrying control timing by controlling the gates of MOSFETs only on the negative potential side of the respective phases so as to easily conduct the rectification and effectively charge the battery with no affection of variations in load and rotations per minute of the motor-generator.

### BRIEF DESCRIPTION OF THE DRAWINGS

FIG. 1 shows a control circuit of a three-phase alternating-current motor-generator, which uses MOSFETs as control elements for each of phases and which works as an inverter when driving the motor-generator as a motor by using a battery and also works as a rectifier when driving the motor-generator as a generator for charging the battery.

FIG. 2 is a timing chart for conducting the on-off control of the gates of MOSFETs both on the positive and negative potential sides of respective phases in the control circuit shown in FIG. 1 in accordance with the output voltage of a three-phase motor-generator when charging a battery.

FIG. 3 shows flows of electric current when conducting the current-carrying control for three-phase rectification by turning on and off the gates of MOSFETs only on the negative potential side of respective phases in the control circuit shown in FIG. 1.

FIG. 4 shows a waveform (a) of three-phase rectification, a waveform (b) of a voltage between a drain D and a source S of each MOSFET and a waveform (c) of an induced voltage of each phase with a neutral point represented by U-phase, which are obtained by turning on and off the gates of MOSFETs only on the negative potential side for respective phases in the control circuit of FIG. 1 according to the present invention.

FIG. 5 shows a waveform (a) of three-phase rectification, a waveform (b) of a voltage between a drain D and a source S of each MOSFET and a waveform (c) of an induced voltage of each phase with a neutral point represented by U-phase when the rectification was made by using each of parasitic diodes D when all MOSFETs on the positive and negative sides of respective phases have been turned off in the control circuit of FIG. 1 according to the present invention.

FIG. 6 shows an equivalent circuit when conducting three-phase rectification by using parasitic diodes in the state that all MOSFETs both on the positive and negative sides for respective phases have been turned off in the control circuit of FIG. 1 according to the present invention.

FIG. 7 shows a waveform (a) of three-phase rectification, a waveform (b) of a voltage between a drain D and a source S of each MOSFET and a waveform (c) of an induced voltage of each phase with a neutral point represented by U-phase when an electric angle of the current carrying control timing was advanced by 60 electric degrees by turning on and off the gates of MOSFETs only on the negative side of respective phases in the control circuit of FIG. 1 according to the present invention.

FIG. 8 shows a waveform (a) of three-phase rectification, a waveform (b) of a voltage between a drain D and a source S of each MOSFET and a waveform (c) of an induced voltage of each phase with a neutral point represented by U-phase made when an electric angle of the current carrying control timing was delayed by 60 electric degrees by turning on and off the gates of MOSFETs only on the negative side of respective phases in the control circuit of FIG. 1 according to the present invention.

FIG. 9 shows characteristics of control voltage versus current, which were determined for the number of rotations per minutes as parameter by conducting the control of the current carrying timing so as to maintain a charging voltage of a battery at a constant value of 14 volts by using the control device according to the present invention.

FIG. 10 shows distribution characteristics of battery charging efficiency versus load current, which was plotted for the number of rotations per minute as parameter by conducting the control of current carrying timing by using the control device according to the present invention.

### PREFERRED EMBODIMENTS OF THE PRESENT INVENTION

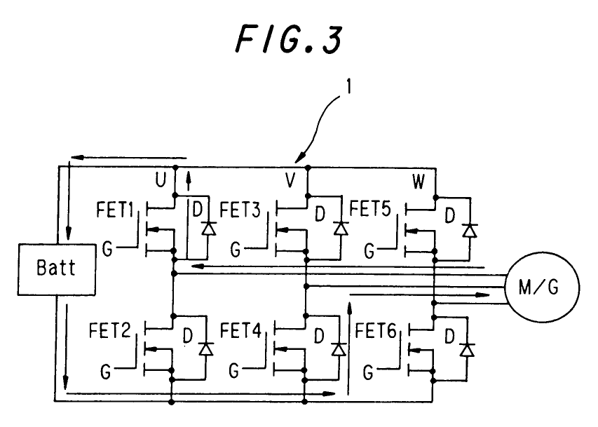

The control device of a three-phase alternating-current motor-generator according to the present invention comprises a control circuit 1 as shown in FIG. 3, which can perform the current carrying control for three-phase rectification by turning on and off the gates of only negative potential side MOSFET 2 (for U phase), MOSFET 4 (for V phase) and MOSFET 6 (for W phase) under the control of a controller (not shown) when driving the motor-generator MG as a three-phase alternating-current generator to generating an output voltage for charging a battery Batt.

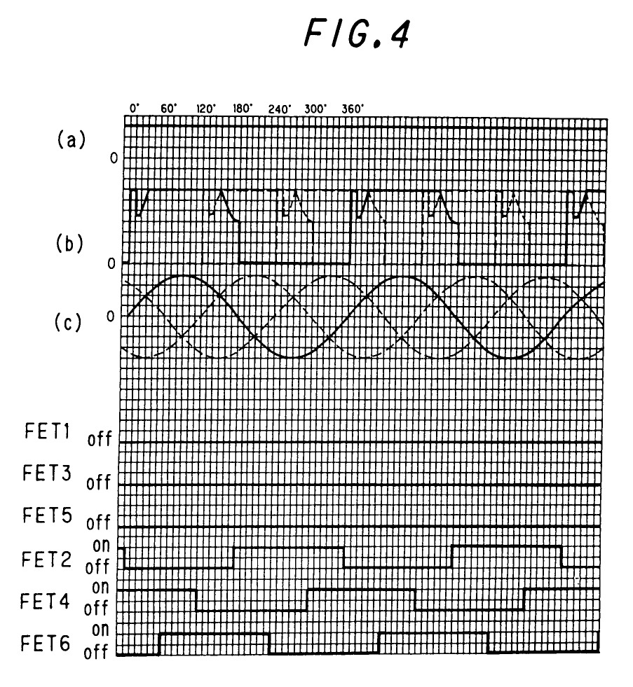

In FIG. 4, there is shown a waveform (a) of three phase rectification, a waveform (b) of a voltage between a drain D and a source S of each of MOSFETs 2, 4 and 6 and a waveform (c) of an induced voltage with a neutral point represented by U phase, which can be obtained in response to turning on-and-off of each of MOSFETs 2, 4 and 6 on the negative potential side for each of three phases. In this case, all MOSFETs 1, 3 and 5 on the positive potential side of respective phases are kept in the OFF state.

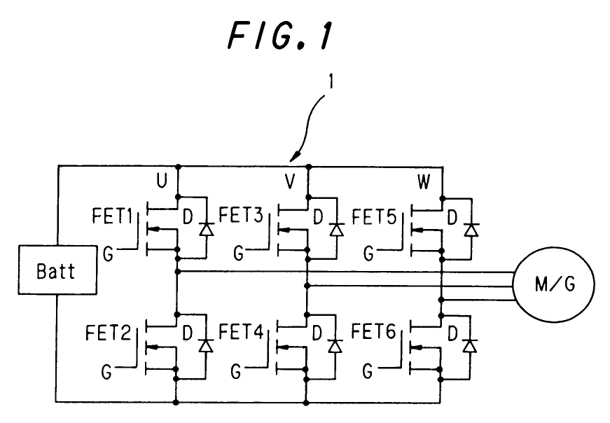

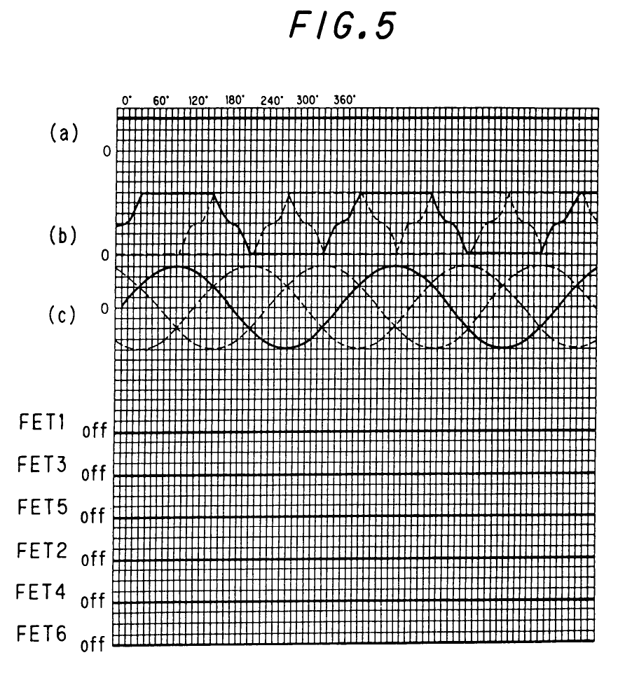

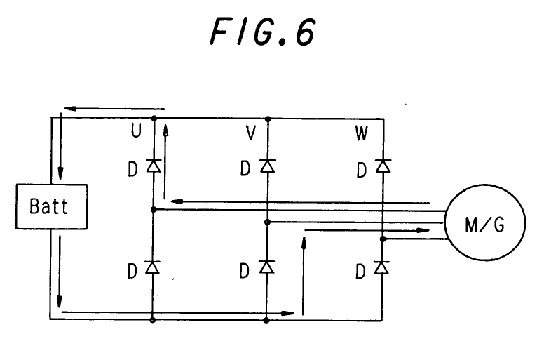

FIG. 5 shows a waveform (a) of three-phase rectification, a waveform (b) of a voltage between a drain D and a source S of each of MOSFETs 2, 4 and 6 and a waveform (c) of an induced voltage with a neutral point represented by the U phase when the rectification was made by using each parasitic diode D on condition that all MOSFETs 1 to 6 on the positive and negative sides for each phase have been turned off. FIG. 6 shows an equivalent circuit of the control circuit 1 when conducting three-phase rectification by using the parasitic diodes on condition that all MOSFETs 1 to 6 on the positive and negative sides for each phase have been turned off in the control circuit of FIG. 1 according to the present invention.

When charging the battery Batt with a voltage produced by the three-phase alternating-current motor-generator MG, the synchronous rectification can be thus conducted by using merely MOSFETs 2, 4 and 6 on the negative potential side of respective phases U, V and W in the control circuit 1, effectively reducing the rectification loss and thereby increasing the efficiency of charging the battery Batt. As compared with the conventional control that conducts ON-OFF control of all MOSFETs 1 to 6 both on the positive and negative potential sides of respective phases, the control device according to the present invention is simple and easy to operate.

In the case of charging the battery Batt with a voltage produced by the three-phase ac motor-generator MG, all MOSFETs 1, 3 and 5 on the positive potential side of respective phases U, V and W in the control circuit 1 are kept as turned OFF, thereby preventing the motor-generator MG from erroneously operating as the motor.

The control device of the three-phase ac motor-generator according to the present invention can perform the advancing/delaying of an electric angle of the current carrying control timing by turning on and off the gates of MOSFETs 2, 4 and 6 only on the negative potential side of respective phases U, V and W in the control circuit 1 under the control of a controller (not shown) in the case of operating the motor-generator MG as the generator for charging the battery Batt with a produced output voltage.

In this case, when an output voltage produced by the three-phase ac motor-generator MG excessively increases or decreases because of the variations in rotation rate and load of the motor-generator MG, the control device advances or delays the electric angle of the current carrying control timing to decrease or increase the output voltage by decreasing or increasing the magnetomotive force, thereby maintaining the constant voltage for charging the battery.

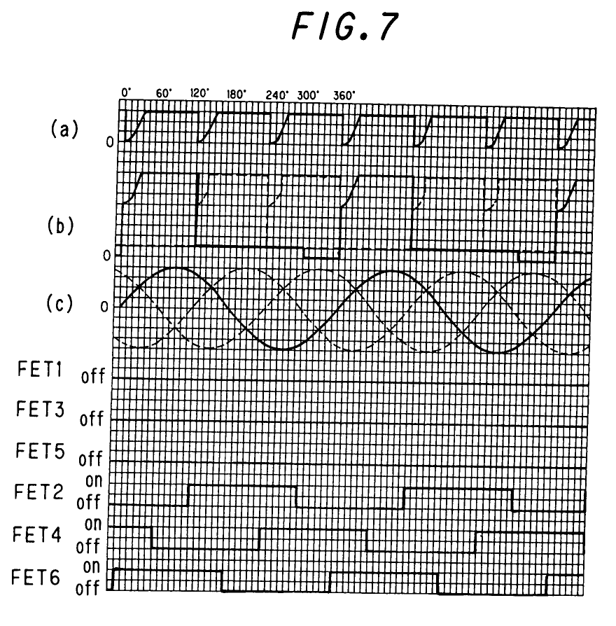

FIG. 7 shows a waveform (a) of three-phase rectification, a waveform (b) of a waveform (b) of a voltage between a drain D and a source S of each MOSFET and a waveform (c) of an induced voltage of each phase with a neutral point represented by U-phase, which were obtained by advancing by 60 electric degree the current carrying control timing for turning on and off the gates of the MOSFETs 2, 4 and 6 only on the negative side of respective phases U, V and W in the control circuit 1. In this case, the gates of MOSFETs 1, 3 and 5 on the positive potential side of respective phases are kept as turned OFF. The charging voltage of the battery Batt is decreased to a specified value owing to the characteristic of the three-phase rectification waveform (a).

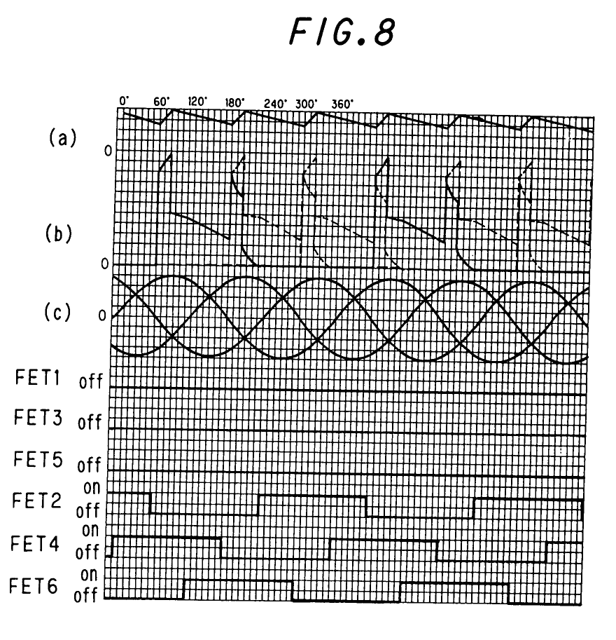

FIG. 8 shows a waveform (a) of three-phase rectification, a waveform (b) of a voltage between the drain D and the source S of each MOSFET and a waveform (c) of an induced voltage of each phase with a neutral point represented by U-phase when an electric angle of the current carrying control timing was delayed by 60 electric degrees by turning on and off the gates of MOSFETs 2, 4 and 6 only on the negative side of respective phases in the control circuit 1. In this case, the charging voltage of the battery Batt is increased to a specified value owing to the characteristic of waveform (a) of the three-phase rectification.

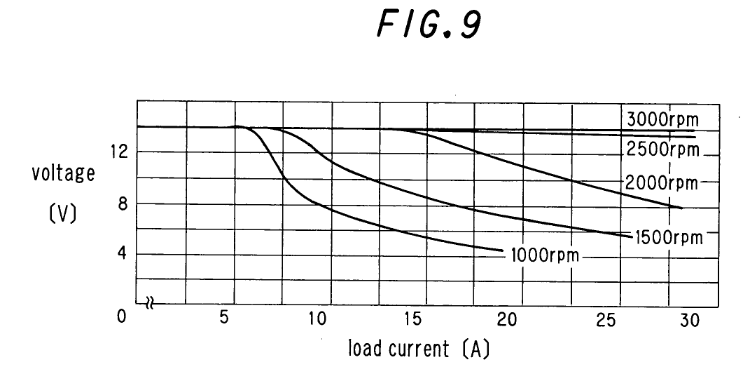

FIG. 9 shows characteristics of control voltage versus load current using as parameter the number of rotations per minutes when conducting the control of the current carrying control timing so as to maintain the charging voltage of a battery at a constant value of 14 volts by using the control device according to the present invention.

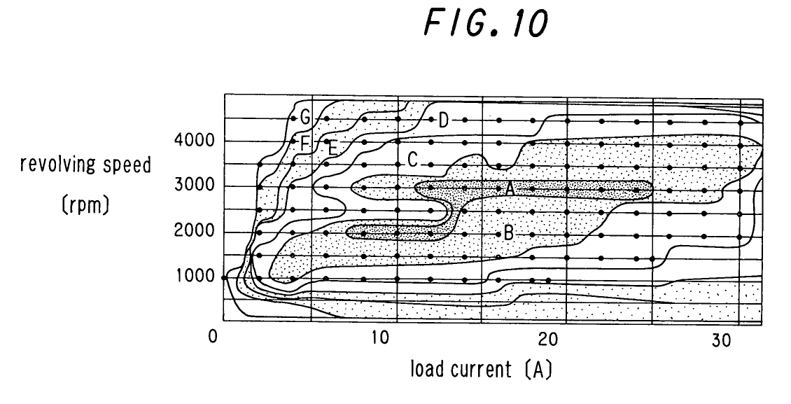

FIG. 10 shows the distribution of battery charging efficiencies with respect to the load current and the number of rotations per minute when conducting the control of the current carrying control timing by the control device according to the present invention. In FIG. 10, the distribution of charging efficiencies is presented as area A of 85 to 90%, area B of 80 to 85%, area C of 70 to 80%, area D of 60 to 70%, area E of 50 to 60%, area F of 40 to 50% and area G of 30 to 40%.

According to the present invention, the current carrying control is conducted to attain the charging efficiency distribution areas A and B shown in FIG. 10.

As is apparent from the foregoing, the control device according to the present invention can conduct the current carrying control of the control of a three-phase alternating-current motor-generator, which comprises MOS field-effect transistors (FET) as control elements for respective phases and operates both as a three-phase inverter circuit for driving the three-phase ac motor and a three-phase rectifier circuit when driving the three-phase ac generator to charge a battery. This control device can easily perform the current carrying control of the three-phase rectification, enabling the three-phase ac motor-generator to effectively charging the battery without affection of variations in rotations per minute and load of the three-phase ac motor-generator. This control device offers the advantage of effectively reducing the battery charging loss and protecting the damage of the system by the overload voltage. It can also generate a voltage sufficient for charging the battery even when driving the generator at a low rotation speed.

The present invention relates to a control device for a three-phase alternating-current motor-generator, which conducts the current carrying control of a control circuit which works as a three-phase inverter circuit for driving the motor-generator as a three-phase alternating-current motor by using a battery and also works as a three-phase rectifier circuit for driving the motor-generator as a three-phase alternating-current generator for charging the battery.

In FIG. 1, M/G designates a three-phase alternating-current motor-generator of the permanent magnet type, Batt designates a battery and D designates a parasitic diode.

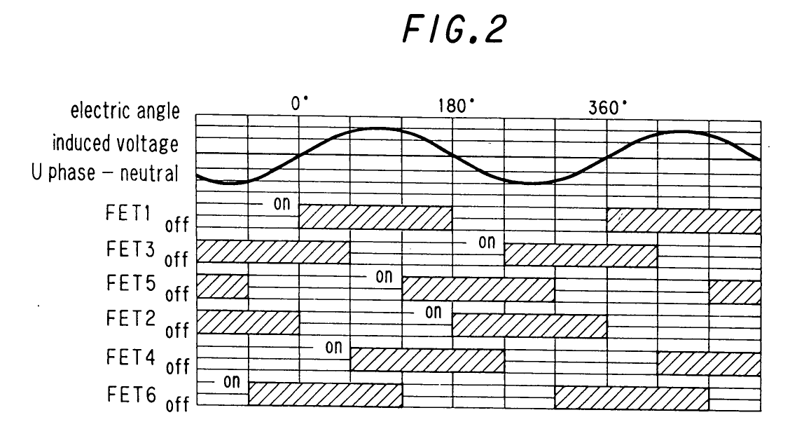

In the above-described conventional control circuit for the three-phase ac motor-generator, the current carrying control is conducted, as shown in FIG. 2, by turning on and off the gates of MOSFETs 1 to 6 both on the positive and negative potential sides for respective phases under the control of a controller (not shown) when operating the motor-generator as the generator for charging the battery Batt.

It is therefore a primary object of the present invention to provide a control device for three-phase alternating-current motor-generator, which conducts the current carrying control of a control circuit which can work both as a three-phase inverter for driving the motor-generator as a three-phase ac motor by using a battery and a three-phase rectifier for driving the motor-generator as a three-phase ac generator for generating power for charging the battery and which uses MOSFETs (Metal Oxide Silicone Field Effect Transistors) as control elements for respective phases, wherein the control device uses a means for performing synchronous rectification by using MOSFETs only on the negative potential side for respective phases in the control circuit when driving the motor-generator for charging the battery and a means for leading and lagging the angle of current carrying control timing by controlling the gates of MOSFETs only on the negative potential side of the respective phases so as to easily conduct the rectification and effectively charge the battery with no affection of variations in load and rotations per minute of the motor-generator.

What is claimed is:

1. A control device for a three-phase alternating-current motor-generator, which is capable of working as a three-phase inverter circuit for driving the motor-generator as a three-phase alternating-current motor by using a battery and also working as a three-phase rectifier circuit for driving the motor-generator as a three-phase alternating-current generator for generating electric power for charging the battery, wherein the control device uses MOSFETs as control elements for each of three phases, characterized in that, when driving the motor-generator as the three-phase alternating-current generator, the control device uses means for performing synchronous rectification by using MOSFETs only on the negative potential side of each of the phases and means for advancing/delaying an electric angle of current carrying control timing by controlling gates of MOSFETs only on the negative potential side of respective phases.
